(19) United States
(12) Patent Application Publication
(10) Pub. No.: US 2026/0202822 A1
(43) Pub. Date: Jul. 16, 2026

(54) HYBRID DIGITAL AND 3D PRINTING PROTOTYPING

(71) Applicant: INTERNATIONAL BUSINESS MACHINES CORPORATION, Armonk, NY (US)

(72) Inventors: Carolina Garcia Delgado, Zapopan (MX); Sarbajit Kumar Rakshit, Kolkata (IN); Jazmin Rodriguez Aguilera, Zapopan (MX); Jeremy R. Fox, Georgetown, TX (US)

(21) Appl. No.: 19/023,862

(22) Filed: Jan. 16, 2025

(51) Int. Cl. G05B 19/4099

(52) U.S. Cl. CPC G05B 19/4099; G05B 2219/49023

(57) ABSTRACT

A computer-implemented method includes generating a digital simulation model of an object, identifying portions of the object for physical prototyping based on confidence scores derived from the digital simulation model and creating a stereolithography (STL) model for the portions. Three-dimensional (3D) printing of the portions is performed based on the STL model. Physical testing is performed on 3D printed portions, and the digital simulation model is updated based on results of the physical testing.

### BACKGROUND

The present invention generally relates to hybrid prototyping and more particularly to digital prototyping with selective supplementation with three-dimensional (3D)/four-dimensional (4D) printing.

Physical prototypes can have advantages over digitally simulated models. For example, digital simulations cannot replicate a full physical interaction and sensory experience of a physical prototype. Users may not be able to physically touch, manipulate, or assess the physical properties, ergonomics, or textures of the product, which can be crucial in evaluating its usability and user experience. Digital simulations often rely on simplified or idealized assumptions about the behavior of materials, components, or systems. These assumptions may not accurately capture the complexity or variability present in the real-world environment, leading to potential inaccuracies or unrealistic results. Digital simulations may not be able to account for all environmental factors and their impact on the performance of a product or system. Variables such as temperature, humidity, vibration, or other external influences may not be adequately incorporated, potentially leading to inaccurate predictions or failure to identify critical issues. Digital simulations rely heavily on input data and models. If the input data is inaccurate or the models are not representative of the real-world behavior, the simulation results may not accurately reflect the actual performance of the product or system.

Physical prototypes provide an opportunity for direct validation and verification of simulation results. Complex simulations involving intricate geometries, multi-physics phenomena, or large-scale systems can require significant computational resources and time. Running simulations at a fine level of detail or incorporating complex interactions can be computationally intensive, limiting the speed and efficiency of simulation-based analysis. Digital simulations often focus on evaluating a specific design configuration or scenario and may not provide the same flexibility as physical prototypes in exploring a wide range of design alternatives, variations, or iterations. Physical prototypes allow for more extensive experimentation and creativity in the design process.

Digital simulations can significantly reduce costs and time in the product development process. Creating physical prototypes can be expensive, requiring materials, manufacturing, and assembly. Digital simulations, on the other hand, can be created and modified quickly and at a lower cost, allowing for rapid iteration and design exploration. Digital simulations enable designers to iterate and refine their designs more efficiently. Changes can be made to a virtual model with minimal cost and time investment, allowing for quick evaluation and optimization of different design options. This iterative process helps in identifying and addressing design flaws early in a development cycle.

### SUMMARY

In accordance with an embodiment of the present invention, a computer-implemented method includes generating a digital simulation model of an object, identifying portions of the object for physical prototyping based on confidence scores derived from the digital simulation model and creating a stereolithography (STL) model for the portions. Three-dimensional (3D) printing of the portions is performed based on the STL model. Physical testing is performed on 3D printed portions, and the digital simulation model is updated based on results of the physical testing.

In accordance with another embodiment of the present invention, a computer system includes a processor set, one or more computer-readable storage media and program instructions stored on the one or more computer-readable storage media to cause the processor set to perform operations. The operations include generating a digital simulation model of an object; identifying portions of the object for physical prototyping based on confidence scores derived from the digital simulation model; creating a stereolithography (STL) model for the portions; controlling a three-dimensional (3D) printer to print the portions based on the STL model; receiving physical testing results for 3D printed portions; and updating the digital simulation model based on the physical testing results.

In accordance with another embodiment of the present invention, a computer program product includes one or more computer-readable storage media and program instructions stored on the one or more computer-readable storage media to perform operations. The operations include generating a digital simulation model of an object; evaluating confidence scores for different portions of the digital simulation model; identifying portions of the object for physical prototyping based on the confidence scores; creating a stereolithography (STL) model for the portions; initiating three-dimensional (3D) printing of the identified portions based on the STL model; and updating the digital simulation model based on physical testing results of the 3D printed portions.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures, wherein:

FIG. 1 is a block diagram of a system for hybrid prototyping with 3D printing, in accordance with an embodiment of the present invention;

FIG. 2 is a perspective view of a large object to be designed and validated using hybrid prototyping, in accordance with an embodiment of the present invention;

FIG. 3 is a flow diagram showing methods for hybrid prototyping with 3D printing, in accordance with an embodiment of the present invention;

FIG. 4 is a block diagram showing a computer environment for hybrid prototyping with 3D printing, in accordance with an embodiment of the present invention; and

FIG. 5 is a flow diagram showing methods for hybrid prototyping with 3D printing, in accordance with an embodiment of the present invention.

### DETAILED DESCRIPTION

In accordance with embodiments of the present invention, systems and methods are described for combining digital prototyping and 3D printing prototyping. A hybrid approach takes advantage of the benefits of each methodology to provide a more efficient and cost-effective design process. While constructing any object, especially large objects, a digital simulation and/or physical prototype are needed. One of the digital simulation or the physical prototype may not be an appropriate solution. A combination of a digital simulation and a physical protype can be optimal while constructing the object; however, a determination needs to be made as to which aspects of the prototype to employ each methodology. In accordance with embodiments of the present invention, based on a context of any activity, appropriate portions of the object to be constructed are apportioned between 3D printing-based prototyping and digital prototyping to identify which portions are to be made with 3D printing-based prototyping, and which portions will be digitally simulated models.

The construction of a large or complex object, such as a bridge, building, auto engine, can include multiple components and systems. These components and systems need to interact to cooperate to achieve a desired fit and function. While constructing any large object, if a simulation is needed, the desired fit and function of the object or system needs to consider specifications of the object (e.g., different component systems, materials, properties of the object, environmental and operational constraints, usage/purpose, etc.). Based on historically captured pros and cons between digital simulation and physical prototypes in different contextual scenarios, a hybrid simulation methodology can be identified and apportioned between portions of the object that can be physically prototyped, and portions of the object which can be digitally simulated. The apportionment can be optimized based on costs, time, or other criteria.

In accordance with an embodiment, initially, a system creates a digital simulation model of the object and simulates the object using the digital simulation model based on various parameters to be considered in the design (e.g., environmental parameters, operational parameters, material properties, etc.). The system identifies initial shapes and dimensions of the object, and portions of the object for 3D printing-based prototyping so that design iterations of 3D printing-based prototyping can be reduced (as the initial shape, dimension, geometry of the physical prototyping will be derived from digital simulation).

The system identifies the portions of the object that will be physically prototyped and can dynamically create a stereolithography (SLT) model. SLT is a rapid prototyping process that fabricates a part layer-wise by hardening a photopolymer with a guided laser beam. Thus, it is a method which involves transferring three-dimensional design details from a Computer Aided Design (CAD) system to produce accurate prototype models for product development and casting. The SLT model can be sent to a 3D printer for 3D printing of the physical prototyping. Before creating SLT models of the portions of the object that include 3D printing-based physical prototyping, the system analyzes the complete digital simulation model of the object to identify which portions of the digital simulation model do not have a threshold confidence level of simulation success results or include insufficient digital data to perform needed quality of simulation results. Accordingly, the portions will be made with 3D printing-based prototyping.

The system dynamically selects appropriate proportions of 3D printing-based prototyping and digital simulation while simulating the object. Based on the simulation results from the 3D printing-based prototype, the system updates the digital simulation model, and a final shape, dimension, geometry of the object to be created.

The system can use the complete digital simulation of the object, enhanced by the simulation result from 3D printing-based prototyping and in an iterative manner, the system can perform a next iteration until the analysis and the design of the object are complete. The proportions between the digital simulation and the 3D printing-based prototyping can change with each iteration.

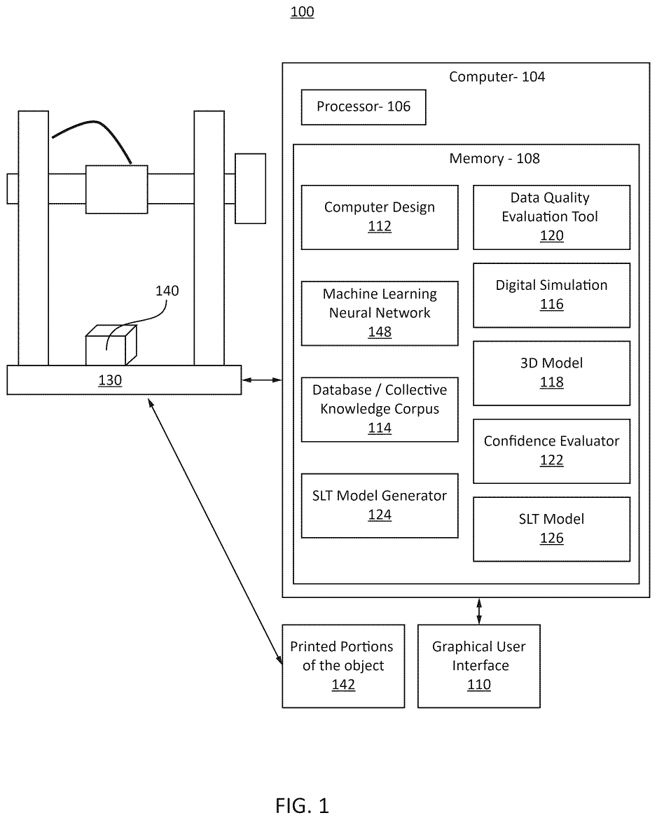

Referring now to the drawings in which like numerals represent the same or similar elements and initially to FIG. 1, a system 100 for hybrid prototyping of an object 140 using digital simulation and 3D/4D printing is shown and described in accordance with embodiments of the present invention. A printer 102 includes an additive manufacturing printer, such as, e.g., a 3D/4D printer.

The system 100 includes one or more processing devices 104. The processing device(s) 104 can include a computer, a cell phone or any other suitable processing device that can run software and store data. The processing device 104 includes one or more processors 106 configured to control operations of the system 100 and to run software stored in a memory 108. The memory 108 can include any form of memory including but not limited to a hard drive with solid state memory.

The memory 108 stores program code that runs features in accordance with embodiments of the present invention. The memory 108 also stores data including one or more computer designs 112 (blueprints) for a model to be apportioned for 3D printing and digital simulation.

The system 100 can be employed to design and simulate the object 140 by using computer aided design tools that can create the one or more computer designs 112. The design can be viewed by a user on a 3D model viewer on a graphical user interface (GUI) 110 of the system 100. The design can be formulated on a same or different computer or a set of computers.

The system 100 stores an initial design, e.g., the one or more computer designs 112. The one or more computer designs 112 need to be analyzed and can be updated based on the analysis. The analysis can include a digital simulation. A digital simulation 116 can include a computer aided design analysis. This can include, for example, a finite element analysis for stress, vibration, heat transfer, etc. An entire design, especially for large or complex systems, would be very expensive and time consuming to analyze in detail digitally. Some aspects of the design may need to be physically modeled. While performing the digital simulation 116 of the object in any given place, several parameters need to be considered. Specific parameters can depend on the nature of the object, purpose of the simulation, etc.

Geometric parameters define a shape, size, and dimensions of the object. The geometric parameters can include, e.g., length, width, height, curvature, and any other relevant spatial characteristics. These parameters are needed for creating an accurate digital representation of the object. Material specific parameters can be specified for materials to be used in different portions of the object to be manufactured. The material specific parameters can include density, elasticity, thermal conductivity, viscosity, strength, and others. Material specific parameters influence how the object behaves under different conditions, such as stress, strain, heat transfer, fluid flow, etc. Environmental parameters in the specific place where the object is to be located need to be considered. This includes parameters such as, e.g., temperature, humidity, pressure, wind speed, or any other relevant factors that can affect the behavior of the object.

Boundary conditions define constraints or interactions the object experiences with its surroundings. These parameters include applied forces, loads, constraints, or other boundary conditions that affect the object's behavior within a simulated environment. Boundary conditions ensure that the simulation accurately represents the interactions between the object and its surroundings.

If the object undergoes motion or deformation, motion parameters need to be considered. These parameters describe the object's movement, velocity, acceleration, rotation, or any other dynamic characteristics. Motion parameters are important for simulating mechanical systems, fluid flow, or any other time-dependent behavior. Operational parameters of the object or the simulation include an initial position, velocity, temperature, or any other relevant properties that define the object's initial state. Accurate specification of initial conditions is needed to ensure the simulation starts from a desired state. Requirement specifications of the object, like the purpose of the object, object use, and requirement specifications.

Historical data from a database 114 or collective knowledge corpus can be employed to identify what types of parameters are considered for the digital simulation 116 of the object in various contextual scenarios. For example, historically, an automobile suspension can be modeled digitally but a body shape can be physically prototyped. This data can be employed to apportion portions of the digital simulation 116 between physical modeling and digital modeling.

Based on requirements, an initial digital 3D model 118 can be created. The 3D model 118 is created by gathering the requirements for the 3D model 118. This involves understanding the purpose of the 3D model 118, its intended use, desired features, dimensions, and any specific constraints or specifications to have a clear understanding of what the 3D model 118 should represent and achieve. Based on the gathered requirements, the 3D model 118 is conceptualized by sketching out rough ideas and designs to help visualize a structure, form, and overall appearance of the 3D model 118. Different angles, perspectives, and details that are relevant to the requirements are considered, using software, and the 3D model 118 can be created.

The 3D model 118 of the object can have types of materials and textures mapped thereon, this includes assigning different visual properties to the model's surfaces, such as color, reflectivity, transparency, roughness, etc. The desired appearance and behavior of the model can be considered in different lighting conditions. Throughout the modelling process, the 3D model 118 can be periodically tested and validated against the requirements to verify that the 3D model 118 aligns with the desired dimensions, features, and functionality. Adjustments or iterations can be made to ensure the 3D model accurately represents and meets the requirements.

Based on the context of the digital simulation 116, and object specifications for the 3D object 140, historical simulation data from database 114 is considered to identify what types of data should be considered for the digital simulation 116 of the 3D object 140. For example, geospatial data can be considered. Geospatial data includes information about the location, terrain, and topography of the simulated area. This can include elevation data, satellite imagery, GIS (Geographic Information System) data, or maps. Geospatial data helps in accurately placing the 3D object 140 within its intended environment and ensuring realistic interactions with the surroundings. Environmental data can be considered. Environmental data includes factors such as weather conditions, temperature, humidity, wind speed, or atmospheric conditions. This data can be employed for simulating realistic environmental effects on the 3D object 140, such as wind forces, heat transfer, or fluid dynamics. Weather data sources, climate models, or meteorological databases can provide relevant information.

Material properties can be considered. Material properties data defines the physical characteristics and behavior of the object's constituent materials. Material properties data includes parameters such as density, elasticity, strength, thermal conductivity, or friction coefficients. Accurate material properties are useful in simulating the object's mechanical response, deformation, or interaction with other elements in the environment.

Motion data can be considered. Motion data describes the movement and behavior of the 3D object 140 or other objects within the digital simulation 116. This can include parameters such as velocity, acceleration, rotation, or trajectories. Motion data allows for the accurate representation of dynamic simulations involving objects in motion, such as vehicles, machinery, or particles. Sensor data can be considered. If the digital simulation 116 involves sensors or measurement devices on the 3D object 140, relevant sensor data can be included. This includes data from cameras, LiDAR (Light Detection and Ranging), radar, or other sensors. Incorporating sensor data enables realistic perception and interaction simulations, such as object detection, tracking, or environment mapping.

Boundary conditions can be considered. Boundary conditions data specify the constraints or interactions imposed on the 3D object 140. Factors such as applied forces, loads, constraints, or environmental interactions are included. Accurate boundary conditions ensure that the digital simulation 116 accurately reflects the object's behavior within the simulated environment. Simulation parameters can be considered. Simulation parameters include settings specific to the software or algorithm being used for the digital simulation 116. These parameters affect the accuracy, stability, and computational efficiency of the digital simulation 116. Examples of simulation parameters include time step, convergence criteria, mesh density, solver settings, etc.

The system 100 can identify availability data in a surrounding region to validate the data sufficiency/quality for the digital simulation 116. For example, based on the context of the digital simulation 116 of the object 140, the system 100 will validate relevance of the data. Irrelevant or unrelated data can lead to inaccurate or misleading simulation results. The system 100 employs a data quality evaluation tool 120 to evaluate completeness of a data set. The data quality evaluation tool 120 also determines if all the necessary data variables, parameters, or inputs needed for the digital simulation 116 are present. Missing data or incomplete information can compromise the accuracy and reliability of the simulation results.

The data quality evaluation tool 120 validates the accuracy of the data by comparing it with known references or experimental data and required quality with respect to historical references stored in the database 114. The data quality evaluation tool 120 evaluates the quality and consistency of the data. Inconsistent or low-quality data can introduce uncertainties and compromise the simulation's reliability. The data quality evaluation tool 120 applies appropriate data validation techniques to identify outliers, anomalies, or inconsistencies in the data set, using statistical analysis, visualization, or domain-specific validation methods to assess the data's quality, distribution, and patterns. This helps identify potential data issues that could affect the simulation. The data quality evaluation tool 120 can also perform a sensitivity analysis to assess the impact of variations or uncertainties in the data on the simulation results.

Based on the types of data identified for the simulation, the quality parameters and sufficiency parameters, the system 100 will perform the digital simulation 116. The system 100 can employ the available data and the quality of the available data for the digital simulation 116.

The system 100 can employ any existing methods for the digital simulation 116 using the available data to identify the simulation results in different portions of the 3D object 140. The correctness or precision level of the digital simulation 116 depends on the types of available data and the quality of available data. Different portions of the 3D object 140 can be made of different material, have different geometry, be subject to different environmental and operational parameters, etc. The system 100 can compare results of the digital simulation 116 to derive a confidence level for different portions of the 3D object 140. The confidence level can be determined based on historic data, pre-determined criteria, other criteria. The confidence score or level reflects the confidence of the digital simulation and/or the confidence that there is adequate data for the digital simulation.

The digital simulation 116 can be divided into portions related to structure, type of response or other linking features or qualities. Each portion can be evaluated to identify a confidence level of the simulation results on each different portion of the 3D object 140 after the simulation. A confidence evaluator 122 can be implemented to apportion the digital simulation 116 of the object 140 to divide the object 140 into logical portions. For example, if the object is a structure, similarly situated beams can be considered together. The logical portions can be determined based upon reference to historically gathered pros and cons of different types of digital simulations and 3D printed physical prototype-based simulations. The historically gathered pros and cons can be stored in the database 114 or collective knowledge corpus.

The confidence evaluator 122 can verify correctness of the digital simulation 116 and validate its results against experimental or empirical data on different portions of the 3D object 140. This can include, e.g., an uncertainty analysis to quantify the uncertainties associated with the simulation results, considering historical pros and cons analyses of different types of simulations. The confidence evaluator 122 can compare the simulation results with experimental data or established benchmarks to determine a confidence score related to each portion of the design for the object 140.

Confidence scores for each portion of the design are identified and compared to thresholds or benchmarks for the 3D object 140. For example, if the digital simulation 116 provided poor results for a portion of the design (e.g., where simulation confidence is poor), the digital simulation 116 can be deemed inadequate, and that portion can be a strong candidate for 3D printing-based simulation. A simulation result confidence level can be assigned to different portions of the 3D object 140 to identify which portions of the 3D object 140 do not have sufficient quality of digital simulation results. Alternately, the confidence evaluator 122 can identify the portions of the 3D object 140 where the data required for simulation is not sufficient or lacks the required quality. The confidence evaluator 122 identifies the portions of the object 140 and their confidence score. Based on the confidence scores, a determination can be made as to which portions of the design of the object 140 can be performed digitally and which will need to be physically prototyped.

In some aspects, the confidence scores for different portions of the object may be computed using various methods and factors. For example, the system 100 can analyze historical data from similar objects or designs to determine accuracy levels for digital simulations of specific components or features. Portions with historically lower simulation accuracy may receive lower confidence scores. More complex geometries or structures may be assigned lower confidence scores, as they may be more challenging to accurately simulate digitally. The system 100 may evaluate factors such as curvature, number of intersecting surfaces, or presence of intricate details. For portions of the object 140 involving materials with less well-defined or variable properties, lower confidence scores may be assigned. This may include new or composite materials with limited simulation data.

Parts of the object 140 expected to be more sensitive to environmental conditions (e.g., temperature fluctuations, humidity, vibrations) may receive lower confidence scores if these factors are difficult to accurately model in the digital simulation. For structural components, the system 100 may assess the criticality of load-bearing requirements. Portions subject to higher or more complex stress distributions may be assigned lower confidence scores. The confidence score may be influenced by the level of detail or resolution used in the digital simulation 116 for each portion. Areas simulated with lower resolution may receive lower confidence scores.

The system 100 may evaluate the quality and completeness of input data for each portion of the object 140, assigning lower confidence scores to areas with incomplete or uncertain input parameters. In some cases, the system 100 may incorporate input from domain experts to adjust confidence scores based on known challenges or limitations in simulating certain types of components. The system 100 may employ machine learning algorithms trained on past simulation and prototyping data to predict the likely accuracy of digital simulations for different object portions.

Portions of the object 140 near complex boundary conditions or interfaces between different materials or components may receive lower confidence scores due to the challenges in accurately modeling these interactions. For objects with dynamic or time-dependent properties, the confidence scores may be lower for portions expected to change significantly over time or usage cycles. Manufacturing process considerations can be factored in the complexity or variability of the manufacturing processes needed for different portions, assigning lower confidence scores to areas that may be more difficult to produce consistently. By combining these and other relevant factors, the system 100 can generate comprehensive confidence scores that reflect the expected reliability of the digital simulation 116 for various portions of the object 140, helping to guide decisions on which areas may benefit most from physical prototyping.

Results of the digital simulation 116 and the 3D model 118 can be employed to generate an SLT model 126 for each portion designated for physical prototyping. The SLT model 126 can be created using an SLT model generator 124. The SLT model generator 124 can include many or all of the features of the 3D model 118 as updated or modified in the digital simulation 116. Once the SLT model 126 is created, then the system 100 can be employed to control one or more 3D printers 130 to create a 3D printed prototype for portions 142 of the object 140.

After printing the portions of the object 140, physical simulation and/or testing can be performed of the portions 142 of the 3D printed portions of the object 140. The portions 142 of the physical object printed with 3D printer 130 can be exposed to an actual environment of usage or a simulated environment of usage to validate the simulation. The physical simulation can be monitored and captured digitally. For example, one or more cameras, Internet of Things (IoT) sensors, other sensors and user entered information can be employed to fine-tune and update the digital simulation 116 with the physical simulation results to complete the digital simulation 116 by enhancing the digital simulation 116 with physical simulation results. The 3D printed portions 142 of the object 140 can be exposed to required environmental testing to provide the physical simulation result which can be used to enhance the digital simulation 116.

The digital simulation 116 and the 3D printed object physical simulation can be aggregated into a single model (e.g., 3D model 118). Actual simulation results can be employed to update a more complete 3D model 118 using the 3D printed prototype portions identified by the confidence evaluator 122 which identified portions 142 of the 3D object 140 that needed to be physically prototyped using the 3D printer 130. The 3D printed simulated results can be used to override the outputs of the digital simulation 116 and can aggregate the 3D printed simulated results with the remaining digital 3D model 118 of the object 140. The process can be iterative and can again simulate the entire 3D digital model 118 with adapted portions from an earlier iteration. The aggregated physical and digital information can be employed to identify what types of changes are applied to the 3D model 118 from the portions 142 where 3D printed prototype is used. Based on the adapted portion of the 3D digital model 118, further iterations of the portions where 3D printing based prototyping is needed can be evaluated. With each new iteration, proportions between digital and physical prototyping can shift toward more digital or more physical as the results are generated.

The confidence evaluator 122 and the data quality evaluation tool 120 as well as other aspects of the system 100 can employ machine learning neural networks 148 to assist in determining information useful in evaluating the data, design techniques, the design parameters, etc., needed to provide confidence scores and to evaluate data adequacy.

The neural networks 148 include a system that improves its functioning and accuracy through exposure to additional empirical data. The neural network 148 becomes trained by exposure to the empirical data. During training, the neural network 148 stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network 148. Each example may be associated with a known result or output. Examples can include outcomes associated with different parameter settings, etc. Each example can be represented as a pair, (x, y), where x represents the input data and y represents the known output. The input data may include a variety of different data types and may include multiple distinct values. The neural network 148 can have one input node for each value making up the example's input data, and a separate weight can be applied to each input value. The input data can, for example, be formatted as a vector, an array, or a string depending on the architecture of the neural network being constructed and trained.

The neural network 148 “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, a trained neural network 148 can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer of source nodes, and a single computation layer having one or more computation nodes that also act as output nodes, where there is a single computation node for each possible category into which the input example could be classified. An input layer can have a number of source nodes equal to the number of data values in the input data. The data values in the input data can be represented as a column vector. Each computation node in the computation layer generates a linear combination of weighted values from the input data fed into nodes of the input layer and applies a non-linear activation function that is differentiable to the sum. The exemplary simple neural network can perform classification on linearly separable examples (e.g., patterns).

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers because they are between the source nodes and output node(s) and are not directly observed. Each node in a computation layer generates a linear combination of weighted values from the values output from the nodes in a previous layer and applies a non-linear activation function that is differentiable over the range of the linear combination. The weights applied to the value from each previous node can be denoted, for example, by w₁, w₂, . . . w_{n-1,} wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

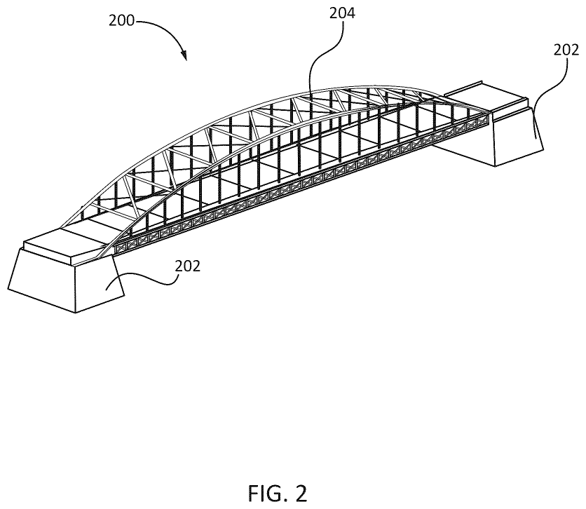

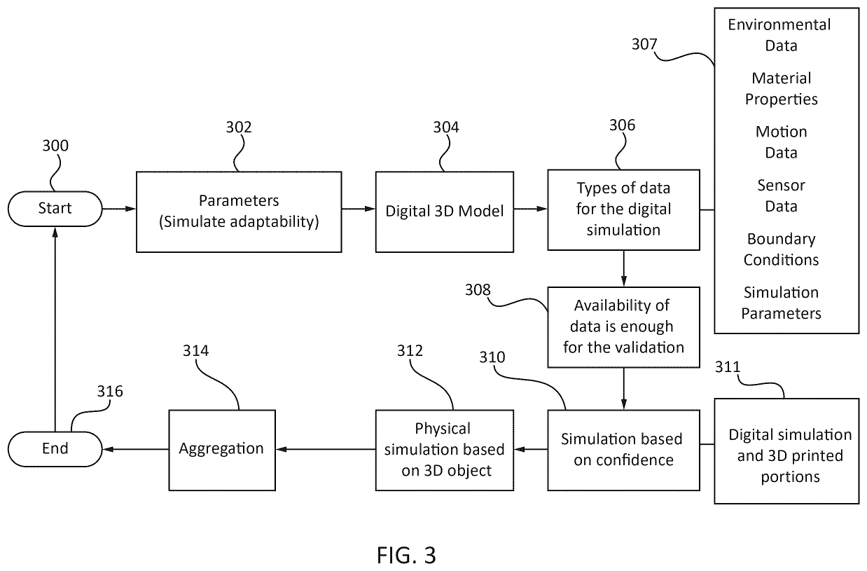

Referring to FIGS. 2 and 3 with continued reference to FIG. 1, a large object 200 includes a bridge to be created, and a simulation is needed to build the large object 200. A specification of the large object 200 is created, which can include, e.g., different types of materials, purposes and usages of different portions of the large object 200, various operational and environmental parameters, etc. Embodiments of the present invention can be employed to identify which portions of the large object 200 will need 3D printed physical prototyping, and which portions will include digital simulation, and how in an iterative manner, the system 100 can use mixed types (hybrid) of simulation to finalize the shape, dimension, geometry of the large object 200.

In block 300, a design is conceived, and a computer design is created. In block 302, the system 100 (FIG. 1) can be employed to assist in the generation of a specification for the large object 200, although this can be performed independently by systems engineering or a client or customer generating a specification for the large object 200. The specification identifies parameters and data needed to design and construct the large object 200. For example, the specification can include the operational, environmental, mechanical, structural, power, electrical, materials, etc. requirements that can be placed on the large object 200. The system 100 can generate a 3D model for a computer design in block 304. In block 306, the system 100 can identify the types of data that are needed and that are available to perform a digital simulation of the large object 200. In block 307, the types of data can include but are not limited to environmental data, materials properties, motion data, sensor data, boundary conditions, simulation parameters, etc.

In block 308, a determination is made as to whether the available data is sufficient to validate the design. This can include generating pros and cons for portions of the large object 200 being simulated using digital simulation or physical simulation including 3D printing. The pros and cons can be generated using historical data. In an embodiment, machine learning algorithms can be employed to search for and generate pros and cons lists for the selection of a prototyping strategy. In an example, a bridge span 204 may be better modeled digitally while abutments 202 of the bridge can be better modeled by 3D prototyping. The system 100 can identify the availability of data for digital simulations. The large objects 200 can be rendered digitally. For example, a digital twin can be created based upon an initial computer design. The digital twin can be subjected to virtual testing to understand how the computer design responds to parameters identified in the specification.

In block 310, the sufficiency of the available data is analyzed to provide a confidence score for the digital simulations. The system 100 can determine which portions of the large object 200 will need physical prototyping. The 3D model can have portions of the design divided between digital simulation portions and 3D printed portions, in block 311. For example, the abutments 202 can be determined as a candidate portion for physical prototyping based upon a confidence score related to the sufficiency of information for the available data. An SLT model can be generated for the portions to be physically modeled based on the computer design and a 3D model can be generated for the large object 200. The SLT models will be printed and tested or simulated in block 312. The printed models of the portions selected for physical prototyping can provide information that is loaded into the digital simulation and/or the 3D model. In block 314, the physical simulation information can be aggregated into the 3D model/digital simulation or be employed to replace or override digital information previously stored. In block 316, the 3D model and/or the digital simulation are updated and can iteratively be improved until the design is optimized.

The system 100 can identify portions of the large object 200 which will need physical prototyping via 3D printing, such that a combination of digital simulations and physical prototyping can be used to construct the large object 200. The system 100 can evaluate the context of activities and the historical pros and cons of digital simulations and physical prototyping in different scenarios to determine which portions of the large object 200 can be or should be physically prototyped. The system 100 can dynamically create 3D printing-based prototypes, analyze digital simulations results of the object, and assess data quality for digital simulation. The system 100 can aggregate the digital simulations and the 3D printed prototype results to finalize the shape, dimension, and geometry of the large object 200.

In an embodiment, the large object 200 includes a bridge to span a river. The design of all components can be digitally provided or performed to ensure the bridge can withstand any external forces. A digital simulation of the bridge can be performed to test and validate the structural integrity. The parameters, such as geometric, material, environmental, and boundary conditions can be determined and simulated accurately. The relevant data can be gathered for the analysis, including geospatial, environmental, material, and motion data, to ensure the simulation results accurately reflect the different forces and motions that occur during construction. After collecting the necessary data, a 3D model is created of the bridge. Once the model is created, digital simulation results are generated. The digital simulation results are compared to established benchmarks to identify any areas which require further testing. For example, if the simulation indicates the bridge is not strong enough for heavy loads, specific areas can be identified which require 3D printing prototyping. The system 100 generates the data for 3D printing to prototype of the identified areas for physical testing. The data is sent to a 3D printer 130 to print the necessary prototypes or portions thereof. The prototypes are printed and tested against the simulation results to validate the accuracy of the simulation. If the simulation results do not match the physical testing results, the process can be repeated, generating different prototypes and simulations until a model is found that accurately reflects a bridge structure that meets specifications. After verifying the model, the structure can be finalized, and construction of the bridge can occur.

The balance between digital and physical prototyping can be optimized for different parameters of groups of parameters. For example, parameters such as speed or prototyping, cost of prototyping, model accuracy, reduced number of iterations, combinations of these and other parameters can be considered to optimize the prototyping process.

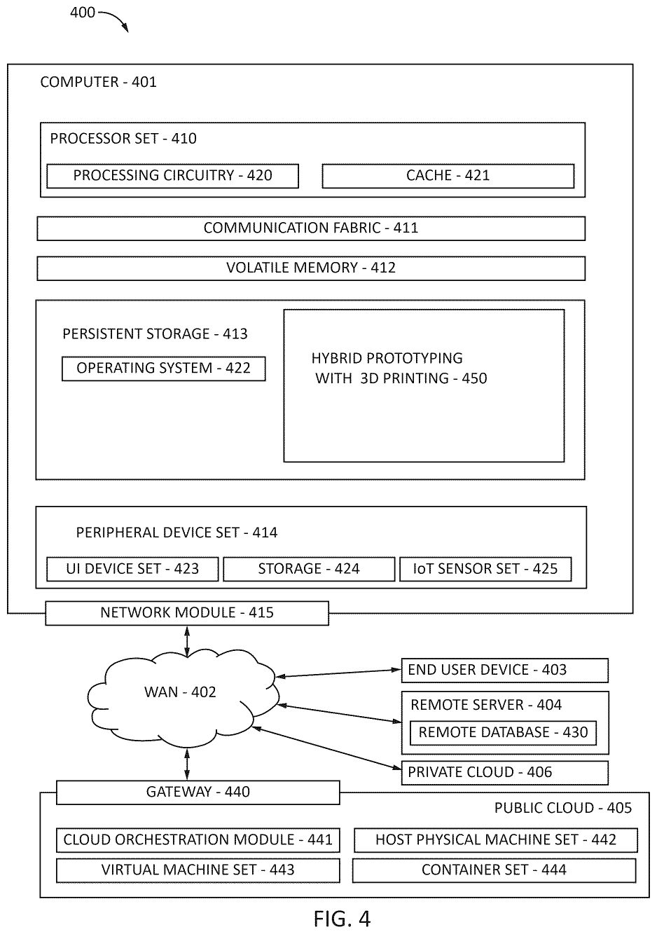

Referring to FIG. 4, a computing environment 400 contains an example of an environment for the execution of at least some of the computer code involved in performing the inventive methods, such as hybrid prototyping with 3D printing 450. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415. WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

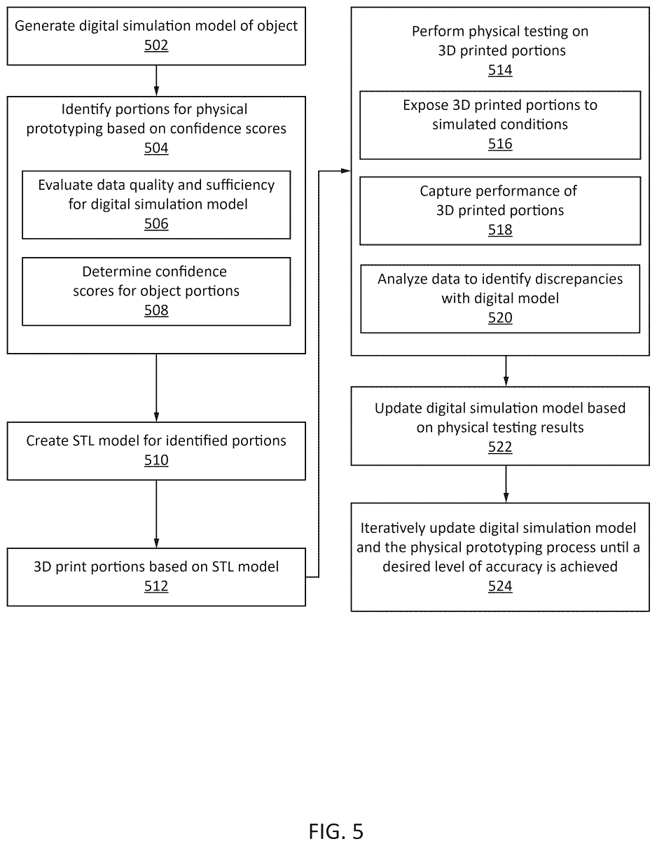

Referring to FIG. 5, a system/computer-implemented method for hybrid prototyping with 3D printing in accordance with embodiments of the present invention is shown and described. In block 502, a digital simulation model of an object is generated. The digital simulation model can be generated using an initial computer design. In block 504, portions of the object are identified for physical prototyping based on confidence scores derived from the digital simulation model.

The portions of the object identified for physical prototyping can include evaluating data quality and sufficiency for the digital simulation model in block 506. Confidence scores can be determined for different portions of the object based on the evaluating, in block 508. The confidence scores can be determined based on historical data of digital simulations and physical prototyping for similar objects. Confidence scores can also be generated in accordance with user set criteria that can weigh different aspects of the prototyping process to bias a type of prototyping based on the set criteria. For example, an amount of useful data may favor one prototyping type over another.

In block 510, a stereolithography (STL) model is created for the portions. In block 512, the portions are three-dimensional (3D) printed based on the STL model. In block 514, physical testing on 3D printed portions is performed. In block 516, the 3D printed portions are exposed to simulated environmental and operational conditions. In block 518, data is captured on the performance of the 3D printed portions under the simulated conditions. In block 520, the captured data is analyzed to identify discrepancies between the physical testing results and the digital simulation model. In block 522, the digital simulation model is updated based on results of the physical testing.

In block 524, the digital simulation model is iteratively updated and the physical prototyping process repeated until a desired level of accuracy is achieved. The desired level of accuracy is determined based on predefined thresholds for discrepancies between the digital simulation model and physical testing results.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method, comprising:
generating a digital simulation model of an object;
identifying portions of the object for physical prototyping based on confidence scores derived from the digital simulation model;
creating a stereolithography (STL) model for the portions;
three-dimensional (3D) printing the portions based on the STL model;
performing physical testing on 3D printed portions; and
updating the digital simulation model based on results of the physical testing.

2. The computer-implemented method of claim 1, wherein identifying portions of the object for physical prototyping includes:
evaluating data quality and sufficiency for the digital simulation model; and
determining confidence scores for different portions of the object based on the evaluating.

3. The computer-implemented method of claim 2, wherein the confidence scores are determined based on historical data of digital simulations and physical prototyping for similar objects.

4. The computer-implemented method of claim 1, wherein performing physical testing on the 3D printed portions includes:
exposing the 3D printed portions to simulated environmental and operational conditions; and
capturing data on performance of the 3D printed portions under simulated conditions.

5. The computer-implemented method of claim 4, further comprising:
analyzing captured data to identify discrepancies between physical testing results and the digital simulation model.

6. The computer-implemented method of claim 1, further comprising:
iteratively updating the digital simulation model and repeating a physical prototyping process until a desired level of accuracy is achieved.

7. The computer-implemented method of claim 6, wherein the desired level of accuracy is determined based on predefined thresholds for discrepancies between the digital simulation model and physical testing results.

8. A system, comprising:
a processor set;
one or more computer-readable storage media; and
program instructions stored on the one or more computer-readable storage media to cause the processor set to perform operations comprising:
generating a digital simulation model of an object;
identifying portions of the object for physical prototyping based on confidence scores derived from the digital simulation model;
creating a stereolithography (STL) model for the portions;
controlling a three-dimensional (3D) printer to print the portions based on the STL model;
receiving physical testing results for 3D printed portions; and
updating the digital simulation model based on the physical testing results.

9. The system of claim 8, wherein identifying portions of the object for physical prototyping includes:
evaluating data quality and sufficiency for the digital simulation model; and
determining confidence scores for different portions of the object based on the evaluating.

10. The system of claim 9, wherein the confidence scores are determined based on historical data of digital simulations and physical prototyping for similar objects.

11. The system of claim 8, wherein the operations further include:
exposing the 3D printed portions to simulated environmental and operational conditions; and
capturing data on performance of the 3D printed portions under simulated conditions.

12. The system of claim 11, wherein the operations further include:
analyzing captured data to identify discrepancies between the physical testing results and the digital simulation model.

13. The system of claim 8, wherein the operations further include:
iteratively updating the digital simulation model and repeating a physical prototyping process until a desired level of accuracy is achieved.

14. The system of claim 13, wherein the desired level of accuracy is determined based on predefined thresholds for discrepancies between the digital simulation model and physical testing results.

15. A computer program product, comprising:
one or more computer-readable storage media; and
program instructions stored on the one or more computer-readable storage media to perform operations comprising:
generating a digital simulation model of an object;
evaluating confidence scores for different portions of the digital simulation model;
identifying portions of the object for physical prototyping based on the confidence scores;
creating a stereolithography (STL) model for the portions;
initiating three-dimensional (3D) printing of the portions based on the STL model; and
updating the digital simulation model based on physical testing results of the portions.

16. The computer program product of claim 15, wherein evaluating confidence scores includes:
analyzing data quality and sufficiency for different portions of the digital simulation model; and
determining the confidence scores based on analysis and historical data of digital simulations for similar objects.

17. The computer program product of claim 16, wherein identifying portions of the object for physical prototyping includes selecting portions with confidence scores below a predetermined threshold.

18. The computer program product of claim 15, wherein the operations further include:
exposing the portions to simulated environmental and operational conditions; and
capturing performance data of the portions under simulated conditions.

19. The computer program product of claim 18, wherein the operations further include:
analyzing the performance data to identify discrepancies between the physical testing results and the digital simulation model.

20. The computer program product of claim 19, wherein the operations further include:
iteratively updating the digital simulation model and repeating a physical prototyping process until discrepancies between the digital simulation model and physical testing results are below predefined thresholds.
